(19) United States
(12) Patent Application Publication
(10) Pub. No.: US 2010/0050947 A1
(43) Pub. Date: Mar. 4, 2010

(54) AUTOMATIC MILKING DEVICE AND METHOD OF CONTROLLING AN AUTOMATIC MILKING DEVICE

(75) Inventor: Martinus Petrus Kortekaas, Lisse (NL)

Correspondence Address: HOWREY LLP-EU, C/O IP DOCKETING DEPARTMENT, 2941 FAIRVIEW PARK DR., SUITE 200, FALLS CHURCH, VA, 22042, US

(73) Assignee: LELY PATENT N.V., Maassluis (NL)

(21) Appl. No.: 12/547,517

(22) Filed: Aug. 26, 2009

(30) Foreign Application Priority Data
Aug. 26, 2008 (NL) 1035870

(51) Int. Cl. A01J 5/007

(52) U.S. Cl. 119/14.02; 119/14.08; 119/14.14

(57) ABSTRACT

An automatic milking device for milking a dairy animal, comprising a control device and a weighing floor with weight sensors for supplying weight signals, and with a filter for filtering the weight signals into a filtered signal indicative of the position of the centre of gravity of the dairy animal, wherein the control device is configured for controlling the milking by the automatic milking device on the basis of the weight signal filtered by the filter. The control device is arranged for controlling the automatic milking device on the basis of the unfiltered weight signal after the milking has been finished. As a result thereof, it is possible to respond more quickly to movements of the dairy animal, without the filter having a delaying effect.

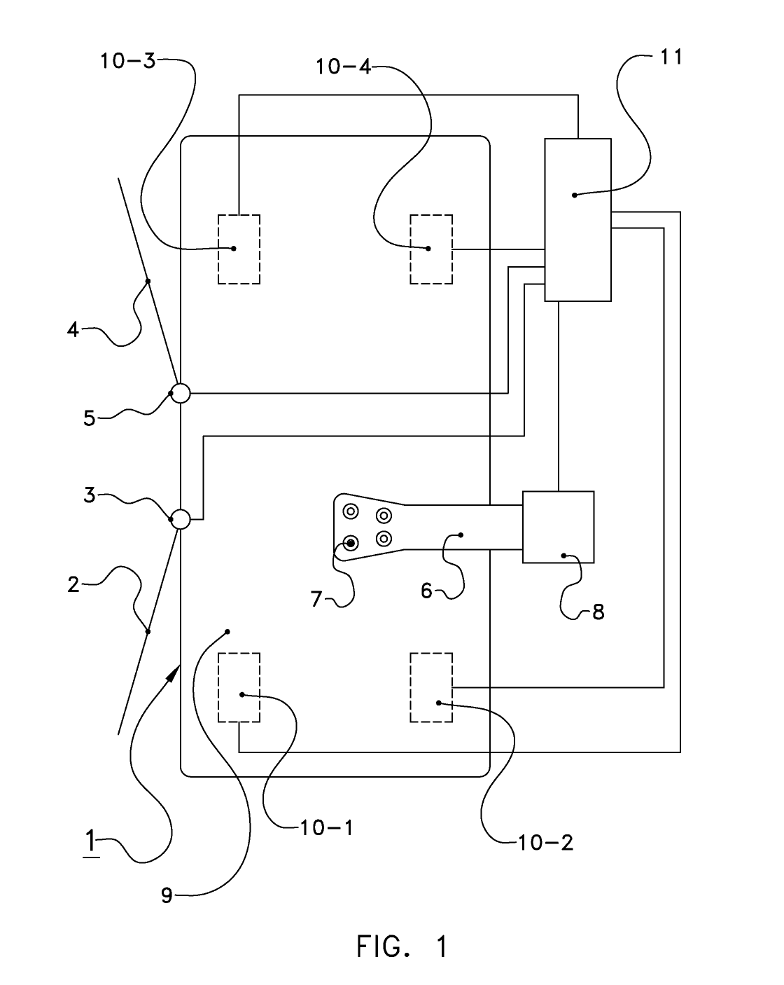

This application claims priority from Netherlands application no. 1035870 filed on Aug. 26, 2008, the contents of which are hereby incorporated by reference in their entirety.

### BACKGROUND OF THE INVENTION

1. Field of the Invention

The present invention relates to an automatic milking device for milking a dairy animal, comprising a control device and a weighing floor with at least one weight sensor for supplying weight signals, and with a filter for filtering the weight signal, wherein the control device is configured for controlling the milking by the automatic milking device on the basis of the weight signal filtered by the filter.

2. Description of the Related Art

U.S. Pat. No. 5,918,566 discloses a device in which a centre of gravity is determined from forces exerted on a weighing floor by the legs of the dairy animal, and from the positions of these forces. On the basis of the calculated centre of gravity the robot arm can be moved in the direction of the udder for milking the dairy animal, in particular in the case when the animal moves in the milking box.

### BRIEF SUMMARY OF THE INVENTION

It is an object of the present invention to have the device function more reliably, in particular after the milking has been finished.

This object is achieved at least partly by means of the automatic milking device with a control device configured for controlling the automatic milking device on the basis of a filtered weight signal before the milking has finished and an unfiltered weight signal after the milking has finished.

Filtering the weight signal is beneficial for calculating the position and movement of the centre of gravity, and to be able to remove outliers in the signals. Using an unfiltered weight signal after the milking has finished enables the device to respond more quickly to variations in the weight signal, and, consequently, to function more reliably. Where it was advantageous to filter the signals during milking, it is advantageous to have the device not doing this after the milking has been finished. The faster response time from using an unfiltered signal is, for example, advantageous to control components of the milking device which have nothing to do with the milking proper. For example, for controlling such components, it may be sufficient to know whether a dairy animal is present, for which purpose the presence of one signal at one of the weight sensors is sufficient. By no longer filtering that signal it will be available sooner for the device. This is because filtering results in a delay, especially when it involves, for example, time averaging.

In principle, it is sufficient to provide only one weight sensor, which, for example, is direction sensitive. On the basis of the signals obtained thereby it is possible to determine the position of the centre of gravity, and of course the weight, in a sufficiently accurate manner. Advantageously, a plurality of weight sensors are provided. These may often be designed more simply, such as, for example, pure weight meters without direction sensitivity. It is possible to determine in a simple and accurate manner, from the different weights as well as from the known positions, the weight and the position of the centre of gravity.

In particular, the filter is switchable between a filtering position and a position for transmitting the weight signal in an unfiltered manner, wherein the control device is configured for switching the filter. In this case, the control device is, for example, configured for switching the filter after a signal finishing the milking or indicating that the milking has been finished. Consequently, from the moment of finishing the milking, the filter will be switched, in order to transmit the weight signal immediately. As a result, the control system is able respond more quickly to variations in the weight signal. By means of this feature, it is possible for the control system make use of the desired quicker signal. Switching of the filter can be achieved in this case by diverting the signal around the filter network, via a relay or the like, or for example by setting an average time of zero or a filter constant equal to 1. It should be noted that the milking should be understood as a complete treatment, which may also comprise cleaning, dipping and the like, i.e. a teat related treatment for which it is important to know the centre of gravity of the cow. It will be possible to have the switching of the filter from the non-filtering position to the filtering position take place from the signal to start the milking, i.e. the extensive variant of the milking, comprising pre-treatment, etc. Until that time the weight signal will thus preferably be transmitted in an unfiltered manner, and the control device is configured accordingly.

A favorable embodiment further comprises a robot arm which is controllable by the control device for applying teat cups to teats. The above mentioned “milking finished” signal is known in the state of the art and is in practice for example accompanied by an action to remove the teat cups. If the robot arm was controlled on the basis of the filtered signal, from the moment of removal of the teat cups it will be less relevant to control the robot arm in this manner. It is now sufficient to control the robot arm on the basis of the unfiltered weight signal.

A favorable embodiment of the device according to the invention, further comprises a milking box with a gate which is controllable by the control device, in particular an exit gate, the closing of which, and optionally also the opening of which, is controllable on the basis of the weight signal, in particular the unfiltered weight signal. In this case, the greater reaction rate of the control device is advantageous, because it is possible to respond more quickly to varying weight signals. In particular if the dairy animal leaves the milking box, it is important to know whether the dairy animal is still partly present in the milking box. If this is the case, i.e. not yet all weight sensors supply a zero signal, the exit gate cannot or may not yet be closed. If, however, there is a time delay in the weight signal, the closing will take place unnecessarily late. By means of the invention it will be possible to respond much more quickly to the actual leaving of the box. But, for example, also in the case of panic when a dairy animal enters or leaves the milking box, in which case a very fast variation of the weight signals will occur, a quick and accurate control of the one or more gates is desired.

The invention also relates to a method of controlling an automatic milking device for milking a dairy animal, comprising a control device and a weighing floor with at least two weight sensors for supplying weight signals, and with a filter for filtering the weight signals into a filtered signal indicative of the position of the centre of gravity of the dairy animal, comprising the control of the milking by the automatic milking device on the basis of the weight signal filtered by the filter, where the automatic milking device is controlled on the basis of the unfiltered weight signal after the milking has been finished. Again it should be noted that “milking” should be understood here as any teat related action, such as cleaning, foremilking, stimulating or dipping. In particular, the automatic milking device will, also prior to the beginning of that teat related action, be controlled on the basis of the unfiltered weight signal

In particular, the automatic milking device comprises a robot arm, and the robot arm is controlled on the basis of the unfiltered weight signal after the teat related action, especially milking, has been finished. In some embodiments, the automatic milking device comprises a milking box with a gate which is controllable by the control device, in particular an exit gate, the closing of which, and optionally also the opening of which, is controlled on the basis of the weight signal, in particular the unfiltered weight signal. These gates are usually only operated when a teat related action is not involved.

### BRIEF DESCRIPTION OF THE DRAWINGS

The invention will be described below with reference to the example shown in the accompanying figure, which is a schematic top view of an embodiment of a milking device according to the invention.

### DESCRIPTION OF ILLUSTRATIVE EMBODIMENT

The following is a description of a certain embodiment of the invention, given by way of example only and with reference to the drawing. The figure shows an automatic milking device comprising a milking box 1 having an entrance gate 2, an entrance gate operating device 3, an exit gate 4 and an exit gate operating device 5, also comprising a robot arm 6 with teat cups 7 and a robot arm operating unit 8. By 9 is denoted a weighing floor, here with four weighing sensors 10-1 to 10-4, while 11 denotes a control device.

Here, the weighing floor 9 comprises four weight sensors 10-1 to 10-4, which are for example piezoelectric cells or load cells. The number of sensors may also be smaller or larger. The sensors each supply a weight signal according to their load. On the basis of these signals and the known position of the sensors it is possible to determine the centre of gravity of a dairy animal present on the weighing floor 9.

The control device 11 is connected both to the weighing sensors 10-1 to 10-4 and to the gate operating devices 3 and 5 and the robot arm operating unit 8. This control device comprises a filter which filters the weight signals, and possibly further processes them, to derive a centre of gravity. This filtered centre of gravity, i.e. the filtered weight signal, can be used by the control device 11 to control the robot arm 6 by means of the robot arm operating unit 8, in order to follow the cow in a controlled manner. This cow following takes place by means of a filtered signal, in order to damp, for example, measurement errors, but also to control the movements of the robot arm in an efficient manner, avoiding unnecessary or jerky movements to prevent unrest with the dairy animals. This filtering is time-consuming (i.e. results in a delay), and after the teat related action has been finished this is no longer necessary. The filter can then be put out of operation and the weight signal can be transmitted in an unfiltered manner. The gate operating devices 3 and 5 can also be operated as described above. It should be noted that the filter may be implemented in hardware, or may be part of a computer program which is configured for controlling the control device 11, forming a sort of signal processing program.

The exemplary embodiment shown only serves as an illustration of the invention, and not as a limitation thereof. It will be recognized that this embodiment is susceptible to various modifications and alternative forms well known to those of skill in the art. Accordingly, although a specific embodiment has been described, this is an example only and is not limiting upon the scope of the invention. The person skilled in the art will be able to apply various modifications and adaptations within the scope of the invention, the scope of protection for the invention being determined by the accompanying claims.

What is claimed is:

1. An automatic milking device for milking a dairy animal, comprising a control device and a weighing floor with at least one weight sensor for supplying a weight signal, and with a filter for filtering the weight signal into a filtered signal indicative of the position of the centre of gravity of the dairy animal, wherein the control device is configured for controlling the milking by the automatic milking device on the basis of the weight signal filtered by the filter, wherein the control device is configured for controlling the automatic milking device on the basis of the weight signal which has not been filtered, after the milking has been finished.

2. The device according to claim 1, wherein the filter is switchable between a filtering position and a position for transmitting the weight signal in an unfiltered manner.

3. The device according to claim 2, wherein the control device is configured for switching the filter.

4. The device according to claim 1, further comprising a robot arm which is controllable by the control device for applying teat cups to teats.

5. The device according to claim 1, further comprising a milking box with a gate which is controllable by the control device, for closing the gate on the basis of the weight signal.

6. The device according to claim 5, wherein the control device closes the gate on the basis of the unfiltered weight signal.

7. The device according to claim 5, wherein the gate is an exit gate.

8. The device according to claim 1, wherein the weighing floor comprises at least two weight sensors.

9. An automatic milking device for milking a dairy animal, comprising:
a weighing floor with at least one weight sensor for supplying a weight signal indicative of the position of the centre of gravity of the dairy animal;
a filter for filtering the weight signal into a filtered weight signal; and
a control device for controlling the automatic milking device on the basis of the filtered weight signal for milking the dairy animal, and for controlling the automatic milking device on the basis of the unfiltered weight signal after the milking has finished.

10. A method of controlling an automatic milking device for milking a dairy animal, comprising a control device and a weighing floor with at least one weight sensor for supplying a weight signal, the method comprising:
receiving an unfiltered weigh signal from the weight sensor indicative of the position of the centre of gravity of the dairy animal;
filtering the weight signal to provide a filtered weight signal;
controlling the automatic milking device on the basis of the filtered weight signal for milking the dairy animal; and
controlling the automatic milking device on the basis of the unfiltered weight signal after the milking has finished.

11. The method according to claim 10, wherein the automatic milking device comprises a robot arm, and the method further comprises controlling the robot arm on the basis of the unfiltered weight signal after the milking has finished.

12. The method according to claim 10, wherein the automatic milking device comprises a milking box with a gate, and the method further comprises closing the gate on the basis of the weight signal.

13. The method according to claim 12, wherein closing the gate is performed on the basis of the unfiltered weight signal.
